(19) United States
(12) Patent Application Publication
(10) Pub. No.: US 2015/0340941 A1
(43) Pub. Date: Nov. 26, 2015

(54) REGENERATIVE ENERGY ELECTRIC MOTOR DRIVEN GENERATOR POWER PLANT SYSTEM

(71) Applicant: Shane GETUTUA, (US)

(72) Inventor: Shane GETUTUA, Talisay City (PH)

(21) Appl. No.: 14/410,066

(22) PCT Filed: Jan. 28, 2013
(86) PCT No.: PCT/PH2013/000003

§ 371 Date: Dec. 20, 2014

(30) Foreign Application Priority Data
Jun. 27, 2012 (PH) 12012000186

(51) Int. Cl. H02K 47/20

(52) U.S. Cl. CPC H02K 47/20; Y10S 74/09; H02K 53/00

(57) ABSTRACT

The present invention relates to regenerative electric energy wherein the electric motor, gear box and generator are configured to produce a continuous flow of electric energy. The invention relates to the driving members of electricity generation such as nuclear, hydroelectric, thermal plant, and wind power. The one embodiment includes inverter with battery charger, and battery, utilizing as initial start-up to AC load usage of electric motor as driving mechanism of generator, and further embodiment a set of breakers as diverting configuration division members of electricity generation of generator wherein the portion of electric energy is diverted back to inverter with built-in switch that can detect and switch automatically and transfer between inverter power and incoming AC power then activate the system and supply continuous AC power to electric motor as regenerative driving source of generator. Then other portion of the regenerative energy is transmitted to end users of electric energy.

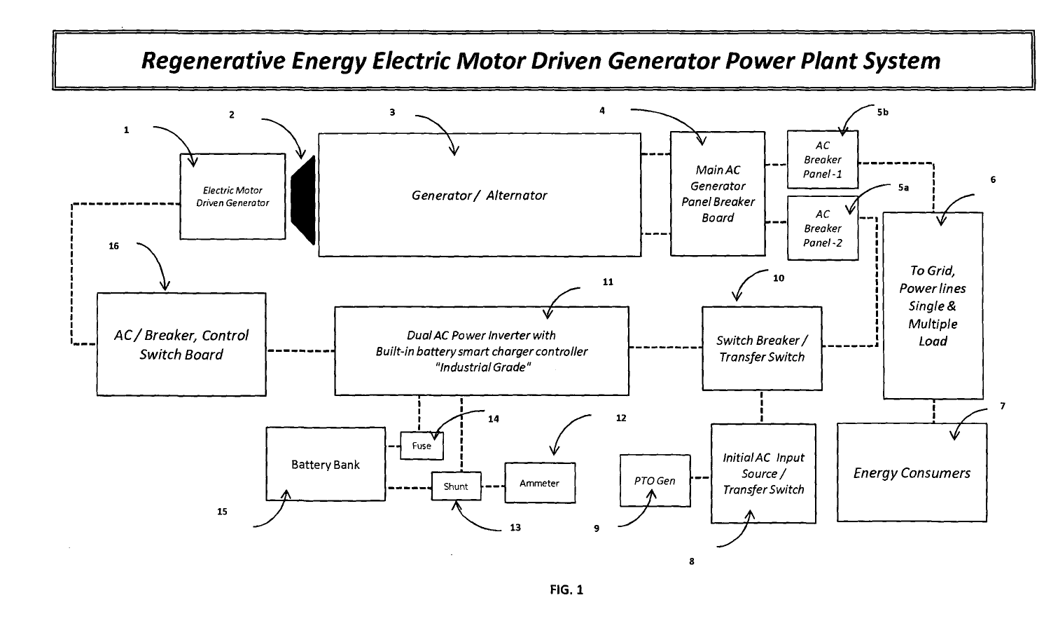

### DETAILED DESCRIPTION

The regenerative energy electric motor driven generator power plant system is a new concept of invention of pure clean regenerative energy resource and the most potential application to reshape the world energy economy as it produces a steady flow of electric energy with ever-greater efficiency and a critical importance to the future of modern civilization.

The regenerative energy electric motor driven generator power plant system is an invention of a new generation of clean energy that efficiently provide electrical energy to the power plant system on a minimal cost to operate, build, maintain and very efficient compared to existing power plants that we have today which is found in a significant distances from major urban and industrial centers, which would require the construction of expensive transmission lines and enormous amount of resources will be required to build a new power plant.

The regenerative energy electric motor driven generator power plant system can be installed anywhere in the major urban and industrial centers within reach in an ever-greater efficiency.

The regenerative energy electric motor driven generator power plant systems can be installed and built in the high rise buildings at a very affordable cost with ever-greater efficiency.

The regenerative energy electric motor driven generator power plant system application will emerge as a potentially serious competitor to fossil fuels such as petroleum, oil, coal, natural gas, and gasoline.

The regenerative energy electric driven generator power plant system invention is using only a method of regenerative energy system to drive generators unlike the nuclear power plants; this invention eventually will be eliminating a complex and costly operation of producing electric energy.

Nuclear power plant stations use the same type of turbines and generators as conventional power stations and it uses Uranium rods as fuel, and heat as generated by nuclear fission neutrons that smash into the nucleus of the uranium atoms, then split roughly in half and release energy in the form of heat, then carbon dioxide or water is pumped through the reactor to take the heat away, which then heats water to make steam. The steam drives turbines which drive generators, which is a conventional practice of driving the generators. And also the waste produced is very dangerous and harmful. Waste-disposal is always an issue and a lot of money is spent on precautionary measures and safety of mankind. A nuclear accident can be a major disaster. Nuclear energy from Uranium is not renewable.

The regenerative energy electric motor driven generator power plant system invention also relates to the method of application of wind turbine power plant system. Wherein wind power is not always predictable-where some days have no wind, suitable areas for wind farms are often near the coast and covering the landscape, it's noisy and it is only worth building wind farms in places that have strong and steady winds.

The regenerative energy electric motor driven generator power plant system invention also relates to the method of application of regenerative energy system on hydro electric power plant. Wherein hydro electric power plant have some disadvantages on high maintenance cost, hydrology dependent “precipitation”, inundation of land and wildlife habitat, loss or modification of fish habitat, fish entrainment or passage restriction, changes in reservoir and stream quality, displacement of local populations, suitable site can be difficult and having impact to the environment and very expensive to build.

The regenerative energy electric motor driven generator power plant system invention also relates to the method of application of geothermal power plant system. Wherein geothermal power plant system has some disadvantages. There are not many places where you can build a geothermal power station, you need hot rocks of a suitable type, and which can be drilled easily, some sites may run out of steam, hazardous gasses and minerals may come up underground, and can be difficult to dispose.

The regenerative energy electric motor driven generator power plant system invention also relates to the method of application of fossil fuels, coal, oil and gas power plant systems as it produces harmful carbon emissions, produces sulphur dioxide, an acidic gas that contributes to the formation of acid rain, and the main draw back of fossil fuel is pollution, produces carbon dioxide, which contributes to the greenhouse effect, warming the Earth. Mining coal can be difficult and dangerous. Strip mining destroys large areas of the landscape. Coal-fired power stations need huge amount of fuels. In order to cope with changing demands for power; the station needs reserve as well. Fossil fuels are not renewable energy resource.

The present invention relates to regenerative electric energy wherein the electric motor is configured as driving members of generator to produce a regenerative flow of electric energy. The electric powered power plant further includes one dual power inverter with smart battery charger and rechargeable battery as initial resource of electric energy members of the electric motor as a driving torque of electric generator, and the electric energy breaker as driving division members of the produced portion of electric energy of the generator which is diverted back to the electric motor as a regenerative energy resource. While the other further portions of produced electric energy will be transmitted to the end users of the electric energy.

The regenerative energy electric motor driven generator power plant system, wherein the electric motor (1) gearbox (2) coupled as the driving element of electric generator (3) then incorporated to main switch breaker (4) and diverting division members AC breaker (5a) to power inverter with built-in battery charger (11) through switch breaker (10) and rechargeable batteries (15) as initial start-up DC power source to AC load usage of electric motor (1) gearbox (2) as a mechanical driving members of electric generator (3) wherein the sum of AC power generated by the generator is associated on the AC breaker panel (5a) as a regenerative energy, AC power application of power inverter (11) and at the same time charge back the battery to full capacity for the power that has been used during the initial load start of the electric motor and as a standby power.

The regenerative energy electric motor driven generator power plant system, wherein the electric motor (1) gearbox (2) coupled as the driving element of electric generator (3) then incorporated to the main switch breaker (4) and diverting division members the AC breaker (5b) wherein the produced AC power of the electric generator (3) the bulk of produced AC power is transmitted to the consumers (7) and passing through transmission grid single and multiple generator (6) as regenerative, free and clean source of energy.

The regenerative energy electric motor driven generator power plant system, wherein the electric motor (1) gearbox (2) and electric generator (3) is directly powered by the sum of the produced portion of AC power generated by the described diverting division members of AC breaker panel (5a) passing through switch breaker (10) to provide AC power to industrial power inverter (11) and produce regenerative energy by providing regenerative energy to electric motor.

The regenerative energy electric motor driven generator power plant system, wherein the electric motor (1) and gearbox (2) driven generator (3) is powered by the industrial inverter with built-in battery smart charger (11) wherein the power incorporated to the one embodiment of the initial AC power source (8) for initial battery charging into the system. Then the further embodiment of the diesel generator (9) is also included as a secondary initial start-up driving members of the electric motor (1) incorporated further to the system.

Regenerative energy electric motor driven generator power plant system, wherein the electric motor (1) with gearbox (2) driven generator (3) is powered by the dual power inverter with built-in battery smart charger (11) from the AC input source (8) as an initial power source.

The regenerative energy electric motor driven generator power plant system, wherein the electric generator (3) is associated to a dual power inverter with built-in smart battery charger (11) and rechargeable batteries (15) which includes AC breaker feeder panel no.1 (5b) and energy AC breaker panel no.2 (5a) as a diverting division members of the application where the preferred embodiment thereof and which have been described.

The regenerative energy electric motor driven generator power plant system, wherein the produced portion of the electric energy of feeder panel no.2 (5a) is diverted back to power inverter with built-in smart battery charger (11) as an alternating current source of one of the embodiments and rechargeable batteries (15) and configured with the power energy breaker (10) and energy breaker (16) for a continuous application in the system.

The regenerative energy electric motor driven generator power plant system, wherein the dual power inverter with built-in smart charger (11) and rechargeable battery (15) to provide electric energy as AC power source to electric motor (1) and gearbox (2) as a driving mechanism of generator (3) to generate electricity on one complete continuous energy in the degree of the describe equations of the source of energy through electric energy AC breaker panel no.1 (5b) as a continuous source of AC power to end users of electric energy, and AC breaker panel no.2 (5a) as a regenerative source of the dual power inverter to provide undisrupted AC power to electric motor.

The regenerative energy electric motor driven generator power plant system, wherein the electric energy that brings back to its original energy state to work in a symmetrical progression that produces repeated uniformed pattern of regenerative energy process of the described equations after diverting the energy and the transmission on the output energy to act upon the input of the regenerative energy method.

### FIELD OF INVENTION

The present invention relates generally to an electric motor powered power plant system and, more particularly, on the driving members of producing a regenerative and clean energy in a competent and most efficient way of increasing energy proficiency and improving the operational performance, productivity, cost reduction, inputs, energy consumptions, waste or pollution.

### BACKGROUND OF THE INVENTION

A standard wind turbine generator is an apparatus in which a rotor head provided with turbine blades rotates by receiving wind force, and a generator is driven by increasing the speed of this rotation by using a gear box, etc., thus generating power. The rotor head is mounted at an end portion of a nacelle, which is installed at the top of a tower erected on the ground, etc. and which is capable of yawing, and is supported so as to be rotatable about a substantially horizontal, laterally oriented rotation axis.

In general, a monopole-type steel tower employing a cylindrical tower shell is often employed as the above-described tower, and the structure thereof is such that a base plate provided at the bottom end of the tower shell is secured to a steel-reinforced concrete foundation with anchoring bolts. Because heat-generating electrical equipment, such as a converter and a transformer, is installed inside such a wind turbine generator in addition to the generator, such electrical equipment needs to be appropriately cooled to continue stable operation.

Basically, an increase of wattage capacity needed requires also additional construction of a standard wind turbine generator with the aforementioned structural requirements. Thus, it is very costly and cumbersome.

### SUMMARY OF THE INVENTION

The regenerative energy electric motor driven generator power plant system is a new concept of invention of pure clean regenerative energy resource and has the most potential application to reshape the world of energy economy as it produces a steady flow of electricity with ever-greater efficiency and of critical importance to the future of modern civilization.

The regenerative energy electric motor driven generator power plant system is an invention of a new generation of clean energy that efficiently provide electrical energy to the power plant system on a minimal cost to operate, build, maintain and very efficient compared to the existing power plants that we have today, which locations has significant distances from major urban and industrial centers, which would require the construction of expensive transmission lines and enormous amount of resources that will be required to build a new power plant.

The regenerative energy electric motor driven generator power plant system can be installed anywhere in the major urban and industrial centers within reach in an ever-greater efficiency.

The regenerative energy electric motor driven generator power plant system application it emerges as a potentially serious competitor to Nuclear, hydroelectric, wind turbine, fossil fuels such as petroleum, oil, coal, natural gas, and gasoline.

The regenerative energy electric motor driven generator power plant system produces energy which is virtually constant, no waste or pollution produced, much more reliable than wind, solar or wave power, nuclear and thermal power. Regenerative energy electric motor driven generator power plant system can increase full power very quickly; electricity can be generated constantly, unlike other power stations.

The aspect of the invention also relates to the method of application of nuclear energy power plant system.

The aspect of the invention also relates to the method of application of wind turbine power plant system.

The aspect of the invention also relates to the method of application of hydro electric power plant systems.

The aspect of the invention also relates to the method of application of geothermal power plant systems.

The aspect of the invention also relates to the method of application of coal power plant systems.

The aspect of the invention also relates to the method of application of electric motor vehicles or automobiles.

The aspect of the invention also relates to the method of application of all types of vessel or ships.

The aspect of the invention also relates to the method of all application of fossil fuels such as coal, oil, gas fuel and others.

The invented regenerative energy use and the invented method have all the advantages corresponding to the use of electric generator and the preferred embodiment thereof and which have been described.

1. The regenerative energy electric motor driven generator power plant system, wherein the electric motor gearbox coupled as the driving element of electric generator then incorporated to main switch breaker and diverting division members AC breaker to power inverter with built-in battery charger through switch breaker and rechargeable batteries as initial start-up DC power source to AC load usage of electric motor gearbox as a mechanical driving members of electric generator wherein the sum of AC power generated by the generator is associated on the AC breaker panel as a regenerative energy, AC power application of power inverter and at the same time charge back the battery to full capacity for the power that has been used during the initial load start of the electric motor and as a standby power.

2. The regenerative energy electric motor driven generator power plant system in accordance with claim 1, wherein the electric motor gearbox coupled as the driving element of electric generator then incorporated to the main switch breaker and diverting division members the AC breaker wherein the produced AC power of the electric generator the bulk of produced AC power is transmitted to the consumers and passing through transmission grid single and multiple generator as regenerative, free and clean source of energy.

3. The regenerative energy electric motor driven generator power plant system in accordance with claim 1, wherein the electric motor gearbox and electric generator is directly powered by the sum of the produced portion of AC power generated by the described diverting division members of AC breaker panel passing through switch breaker to provide AC power to industrial power inverter and produce regenerative energy by providing regenerative energy to electric motor.

4. The regenerative energy electric motor driven generator power plant system in accordance with claim 1, wherein the electric motor and gearbox driven generator is powered by the industrial inverter with built-in battery smart charger wherein the power incorporated to the one embodiment of the initial AC power source for initial battery charging into the system. Then the further embodiment of the diesel generator is also included as a secondary initial start-up driving members of the electric motor incorporated further to the system.

5. The regenerative energy electric motor driven generator power plant system in accordance with claim 1, wherein the electric motor with gearbox driven generator is powered by the dual power inverter with built-in battery smart charger from the AC input source as an initial power source.

6. The regenerative energy electric motor driven generator power plant system in accordance with claim 1, wherein the electric generator is associated to a dual power inverter with built-in smart battery charger and rechargeable batteries which includes AC breaker feeder panel no. I and energy AC breaker panel no.2 as a diverting division members of the application where the preferred embodiment thereof and which have been described.

7. The regenerative energy electric motor driven generator power plant system in accordance with claim 1, wherein the produced portion of the electric energy of feeder panel no.2 is diverted back to power inverter with built-in smart battery charger as an alternating current source of one of the embodiments and rechargeable batteries and configured with the power energy breaker and energy breaker for a continuous application in the system.

8. The regenerative energy electric motor driven generator power plant system in accordance with claim 1, wherein the dual power inverter with built-in smart charger and rechargeable battery to provide electric energy as AC power source to electric motor and gearbox as a driving mechanism of generator to generate electricity on one complete continuous energy in the degree of the describe equations of the source of energy through electric energy AC breaker panel no. 1 as a continuous source of AC power to end users of electric energy, and AC breaker panel no.2 as a regenerative source of the dual power inverter to provide undisrupted AC power to electric motor.

9. The regenerative energy electric motor driven generator power plant system in accordance with claim 1, wherein the electric energy that brings back to its original energy state to work in a symmetrical progression that produces repeated uniformed pattern of regenerative energy process of the described equations after diverting the energy and the transmission on the output energy to act upon the input of the regenerative energy method to claim 1.
